(19) United States
(12) Patent Application Publication
(10) Pub. No.: US 2014/0071810 A1
(43) Pub. Date: Mar. 13, 2014

(54) COMMUNICATION SYSTEM AND PROCESSING METHOD THEREFOR

(71) Applicant: Hitachi Metals, Ltd., Tokyo (JP)

(72) Inventor: Wataru Kumagai, Ichikawa (JP)

(73) Assignee: Hitachi Metals, Ltd., Tokyo (JP)

(21) Appl. No.: 14/018,312

(22) Filed: Sep. 4, 2013

(30) Foreign Application Priority Data
Sep. 11, 2012 (JP) 2012-199840

(51) Int. Cl. H04L 12/24

(52) U.S. Cl. CPC H04L 41/0654
USPC 370/220

(57) ABSTRACT

A communication system includes a redundancy network, which includes first and second switch apparatuses and employs a ring protocol or the like, and third switch apparatuses. The first and second switch apparatuses function logically as a signal switch apparatus (MLAG). Each third switch apparatus operates with link aggregation (LAG) being set between the third switch apparatus and the first and second switch apparatuses. When a failure occurs in communication between redundant ports of the first and second switch apparatuses, a fourth switch apparatus supporting the ring protocol performs control to put master and slave ports thereof into an open state and the second switch apparatus performs control to put user ports thereof into a blocking state.

The present application is based on Japanese patent application No. 2012-199840 filed on Sep. 11, 2012, the entire contents of which are incorporated herein by reference.

### BACKGROUND OF THE INVENTION

1. Field of the Invention

The present invention relates to a communication system and a processing method therefor, and relates to, for example, a technology that is effective when applied to a communication system in which a technology for link aggregation between a switch apparatus and a plurality of switch apparatuses is combined with various redundancy protocols, as well as to a processing method for the communication system.

2. Description of the Related Art

For example, Japanese Unexamined Patent Application Publication No. 2008-78893 discloses a configuration that includes a pair of intermediate switch apparatuses, a higher switch apparatus, and lower switch apparatuses. The intermediate switch apparatuses are connected to each other via ports for redundancy. The higher switch apparatus and the lower switch apparatuses are connected to ports that are included in the intermediate switch apparatuses and that are assigned the same port number, with corresponding link aggregations being set therefor. Japanese Unexamined Patent Application Publication No. 2009-232400 discloses a method for performing band control of a link aggregation group set between one apparatus and multiple apparatuses.

### SUMMARY OF THE INVENTION

For example, various redundancy protocols have been known, such as those typified by Spanning Tree Protocol (STP), ring protocols, and so on. For example, as disclosed in Japanese Unexamined Patent Application Publication No. 2008-78893 and Japanese Unexamined Patent Application Publication No. 2009-232400, there are known systems in which two switch apparatuses are connected to each other to cause the two switch apparatuses to function logically (virtually) as a single switch apparatus and link aggregation is set for communication links between another switch apparatus and the single virtual switch apparatus.

More specifically, in the link aggregation system, for example, communication links are established from one switch apparatus at a user end to two switch apparatuses included in the single virtual switch apparatus, and link aggregation is set for the two communication links. That is, link aggregation is set between one switch apparatus and two switch apparatuses, unlike typical link aggregation set between two switch apparatuses. With such a system, redundancy against a failure in a switch apparatus can be achieved in addition to the advantages attained by typical link aggregation, such as an increase in the communication bandwidth and redundancy against a failure in a communication link. Such a system is hereinafter referred to as “multi-chassis link aggregation”.

Under such a situation, the present inventor et al. have studied applying multi-chassis link aggregation to communication networks having various redundancy protocols as mentioned above. As a result of this study, we found that, when multi-chassis link aggregation is used, signal loops can occur even when each redundancy protocol works properly in response to a failure.

The present invention has been made in view of such a situation, and an object of the present invention is to provide a communication system and a processing method which can prevent signal loops. The object, other objects, and novel features of the present invention will become apparent from the description herein and the accompanying drawings.

An overview of typical embodiments of the invention disclosed herein will be briefly described below.

A communication system according to the embodiments includes a redundancy network, which includes first and second switch apparatuses, and a third switch apparatus. The first and second switch apparatuses have corresponding first ports that are connected to each other through a shared communication link. In the redundancy network, the first and second switch apparatuses have corresponding second ports that are connected to each other through at least one switch apparatus. The third switch apparatus is connected with the third ports of the first and second switch apparatuses through communication links to operate with link aggregation being set for the corresponding communication links. When a failure occurs in communication between the first ports of the first and second switch apparatuses, the redundancy network causes an actual data signal to be transmitted between the second ports of the first and second switch apparatuses in accordance with an arbitrary redundancy protocol, and the first switch apparatus performs control to put the third port thereof into a blocking state.

The typical embodiments of the invention disclosed herein have an advantage in that signal loops can be prevented.

### BRIEF DESCRIPTION OF THE DRAWINGS

FIG. 1 is a schematic diagram illustrating one example of the configuration of a communication system according to a first embodiment of the present invention;

FIG. 2 is a block diagram illustrating an example of a general configuration of a major portion of each of switch apparatuses (in FIG. 1) constituting multi-chassis link aggregation;

FIG. 3 is a schematic diagram illustrating one example of the configuration of a communication system according to a second embodiment of the present invention;

FIG. 4 is a schematic diagram illustrating one example of a problem that is a premise in the communication system illustrated in FIG. 3;

FIG. 5 is a schematic diagram illustrating one example of an advantage of the communication system illustrated in FIG. 4;

FIG. 6 is a block diagram illustrating an example of a general configuration of a major portion of each of switch apparatuses (in FIG. 3) constituting multi-chassis link aggregation;

FIG. 7 is a schematic diagram illustrating one example of the configuration of a communication system according to a third embodiment of the present invention;

FIG. 8A and FIG. 8B are schematic diagrams illustrating an example of a general operation of a ring protocol;

FIG. 9 is a schematic diagram illustrating one example of a problem in a communication system studied as a premise in the present invention; and

FIGS. 10A and 10B are schematic diagrams illustrating an example of a general operation for a ring protocol, the operation being different from that in FIGS. 8A and 8B.

### DESCRIPTION OF THE PREFERRED EMBODIMENTS

For the sake of convenience, a description given hereinafter is separated into multiple sections or embodiments, when necessary. However, unless otherwise explicitly stated, the sections or embodiments are not independent of each other but may be related to each other in such a way that one is a modification, a detailed description, a supplementary description, or the like of part of or the entirety of another. In addition, when the number of elements and so on (including the number of apparatuses, an amount, a numeric value, a range, etc.) are stated in the embodiments hereinafter, it is to be noted that the values thereof are not limited to particular values and may be greater or smaller than particular values, for example, unless otherwise explicitly stated or unless the values are apparently limited to particular values in principle.

In addition, needless to say, in the embodiments hereinafter, the elements (including element steps and so on) are not necessarily essential, for example, unless otherwise explicitly stated or unless apparently deemed to be essential in principle. Similarly, when the shape of an element or the like, a positional relationship, or the like is stated in the embodiments hereinafter, it is to be noted that the embodiments also encompass those that are substantially similar, approximate, or equivalent to the corresponding shape or the like in the embodiments, for example, unless otherwise explicitly stated or unless apparently deemed to be otherwise in principle. The same also applies to numeric values and ranges disclosed herein.

The embodiments of the present invention will be described below in detail with reference to the accompanying drawings. In the drawings used to describe the embodiments, the same or similar members are denoted by the same reference numerals and repeated descriptions thereof are not given.

### First Embodiment

### General Configuration of Communication System

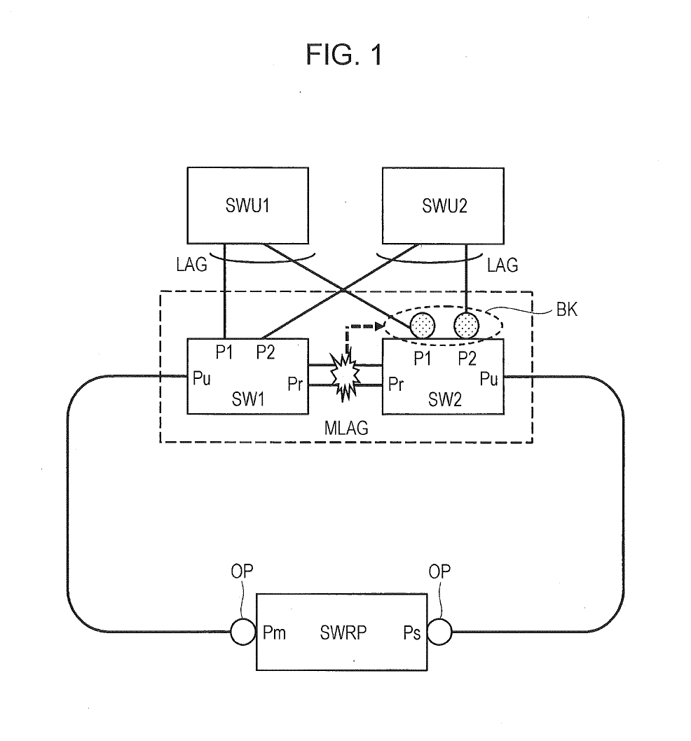

FIG. 1 is a schematic diagram illustrating one example of the configuration of a communication system according to a first embodiment of the present invention. The communication system illustrated in FIG. 1 includes a switch apparatus (a fourth switch apparatus) SWRP supporting a ring protocol, switch apparatuses (first and second switch apparatuses) SW1 and SW2, and switch apparatuses (third switch apparatuses) SWU1 and SWU2, which are connected to the switch apparatuses SW1 and SW2. The switch apparatus SWRP and the switch apparatuses SW1 and SW2 are included in a ring network. In this example, a port (a second port, uplink port) Pu of the switch apparatus SW1 is connected to a port (a master port) Pm of the switch apparatus SWRP and a port (a second port, uplink port) Pu of the switch apparatus SW2 is connected to a port (a slave port) Ps of the switch apparatus SWRP.

The switch apparatuses SW1 and SW2 have corresponding ports (first ports, redundant ports) Pr that are connected to each other through a communication link for bridging (i.e., a shared communication link), thereby realizing multi-chassis link aggregation (MLAG). In this case, the switch apparatuses SW1 and SW2 function logically (virtually) as a single switch apparatus. The communication link for bridging (i.e., the shared communication link) is typically constituted by two communication links in order to provide redundancy.

The switch apparatus SWU1 has two ports, one of which is connected to a port (a third port, user port) P1 of the switch apparatus SW1 through a communication link and the other of which is connected to a port P1 (a third port, user port) of the switch apparatus SW2 through a communication link. The switch apparatus SWU1 operates with link aggregation (LAG) being set for the two communication links (and the two ports) established from the switch apparatus SWU1 to the corresponding switch apparatuses SW1 and SW2. Similarly, the switch apparatus SWU2 has two ports, one of which is connected to a port (a third port, user port) P2 of the switch apparatus SW1 through a communication link and the other of which is connected to a port P2 of the switch apparatus SW2 through a communication link. The switch apparatus SWU2 also operates with link aggregation (LAG) being set for the two communication links (and the two ports) established from the switch apparatus SWU2 to the corresponding switch apparatuses SW1 and SW2.

When multi-chassis link aggregation (MLAG) as described above is used, for example, frames output from the switch apparatus SWU1 are sorted into the two communication links, included in the link aggregation (LAG), in accordance with a predetermined rule using predetermined information (e.g., a destination MAC address), so that the sorted frames are processed by the corresponding switch apparatuses SW1 and SW2. This can increase the communication bandwidth. For example, if one of the two communication links included in the link aggregation (LAG) fails, communication can be sustained through fallback to the other communication link. In addition, if one of the switch apparatuses SW1 and SW2 fails, communication can also be sustained through fallback to the other switch apparatus. This can improve failure tolerance.

### <Overview of Ring Protocol and Problem Therewith>

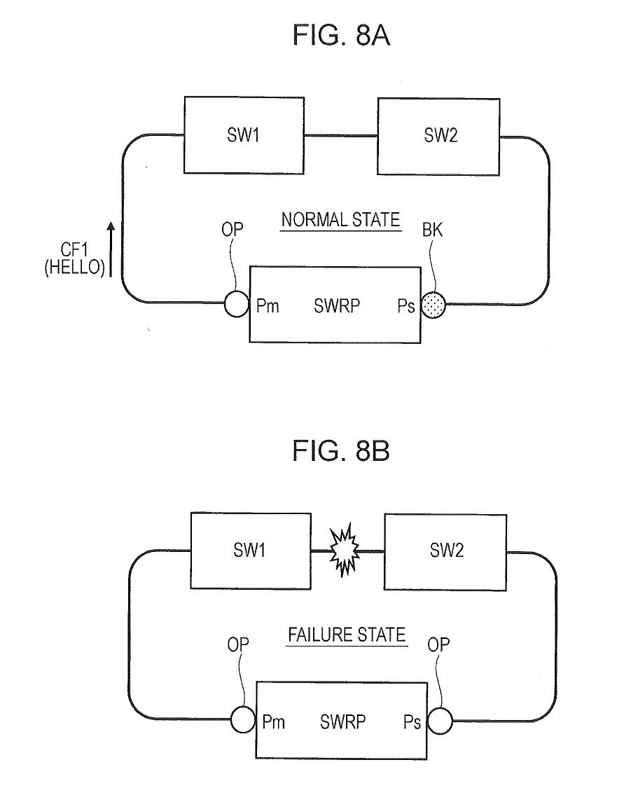

Before an operation of the communication system illustrated in FIG. 1 is described, a description will be given of an overview of a ring protocol and a problem that arises when multi-chassis link aggregation (MLAG) is directly applied to a network employing a ring protocol, as in the case of the communication system illustrated in FIG. 1. FIG. 8A and FIG. 8B are block diagrams illustrating an example of the general operation of a ring protocol. As illustrated in FIGS. 8A and 8B, when a ring protocol is employed, at least one switch apparatus SWRP supporting the ring protocol is provided. A port (a master port) Pm of the switch apparatus SWRP is connected to a port (a slave port) Ps of the switch apparatus SWRP through a communication link and one or more switch apparatuses (SW1 and/or SW2) provided on the communication link, thereby constituting a ring network.

In a normal state in which no failure exists in the ring network, the switch apparatus SWRP performs control to put the port (the master port) Pm into an open state OP and performs control to put the port (the slave port) Ps into a blocking state BK, as illustrated in FIG. 8A, to thereby prevent signal loops in the ring network. In the open state OP, both user frames, which serve as actual data signals, and control frames, which serve as signals for communication management, are transmitted, and in the blocking state BK, user frames are blocked and only control frames are transmitted. On the other hand, when a failure occurs in the ring network (e.g., when a failure occurs in the communication link between the switch apparatuses SW1 and SW2), the switch apparatus SWRP performs control to put both of the ports Pm and Ps into the open state OP, as illustrated in FIG. 8B, thereby ensuring a communication path in the ring network without the occurrence of signal loops. The presence/absence of a failure in the ring network can be determined based on, for example, whether or not a control frame CF1 (e.g., a frame including information called “hello”) can be sent from the port Pm of the switch apparatus SWRP and received at the port Ps.

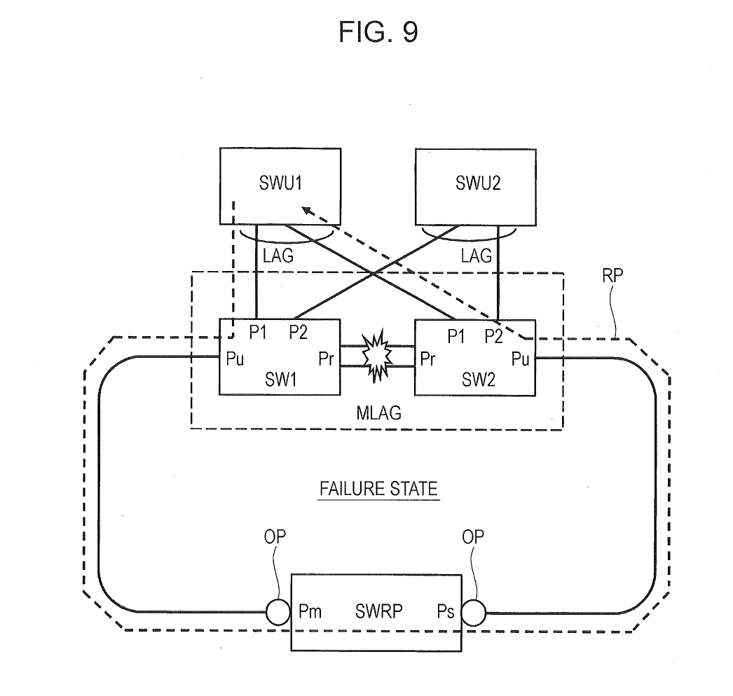

However, when multi-chassis link aggregation (MLAG) is applied to the switch apparatuses SW1 and SW2 in a state as illustrated in FIG. 8B, the following problem arises. FIG. 9 is a block diagram illustrating one example of a problem in a communication system studied as a premise in the present invention. In the example of FIG. 9, for example, a user frame (e.g., a broadcast frame) output from a switch apparatus SWU1 is sent out to the ring network via a switch apparatus SW1 and is input to a switch apparatus SW2 via a switch apparatus SWRP (supporting the ring protocol) in which both ports Pm and Ps are in the open state OP. The user frame is then returned from the switch apparatus SW2 to the switch apparatus SWU1, thereby causing a problem of signal loops RP.

### <General Operation of Communication System>

In the communication system illustrated in FIG. 1, as a premise, a failure exists in communication between the ports (the first ports, redundant ports) Pr of the switch apparatuses (the first and second switch apparatuses) SW1 and SW2. In this case, in accordance with the ring protocol (redundancy protocol), the switch apparatus SWRP causes actual data signals to be transmitted between the ports (the second ports, uplink ports) Pu of the switch apparatuses SW1 and SW2, as described above with reference to FIGS. 8A and 8B. In addition, in this case, the communication system illustrated in FIG. 1 performs control to put the ports (the third ports, user ports) P1 and P2 of one of the switch apparatuses SW1 and SW2 into a blocking state (i.e., a state in which actual data signals are blocked and signals for communication management are transmitted). This control is one main feature of the communication system. With this feature, it is possible to prevent signal loops RP as illustrated in FIG. 9. In addition, even in this state, for example, communication between a terminal connected to the switch apparatus SWU1 or SWU2 and a terminal connected to the switch apparatus SWRP is automatically performed via the switch apparatus SW1 by a redundancy function of the multi-chassis link aggregation (MLAG).

A user may appropriately determine which of the switch apparatuses SW1 and SW2 is used to perform such a signal-loop (RP) prevention operation. However, when both of the switch apparatuses SW1 and SW2 are used for the signal-loop prevention operation, the communication is disconnected. Thus, either one of the switch apparatuses SW1 and SW2 is used. For example, in the example of FIG. 1, when a failure occurs in communication between the ports (the first ports, redundant ports) Pr of the switch apparatuses SW1 and SW2, only the switch apparatus SW2 performs control to put the ports (the third ports, user ports) P1 and P2 thereof into the blocking state. In FIG. 1, when the communication system recovers from the failure, the port (the slave port) Ps of the switch apparatus SWRP is changed from the open state OP to the blocking state BK, and then the ports (the user ports) P1 and P2 of the switch apparatus SW2 are changed from the blocking state BK to the open state OP.

### <Configuration of Major Portion of Switch Apparatus (for MLAG)>

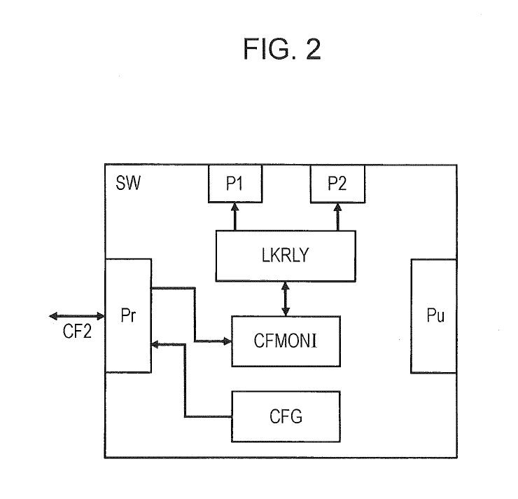

FIG. 2 is a block diagram illustrating an example of the general configuration of a major portion of each of the switch apparatuses SW1 and SW2 (in FIG. 1) constituting the multi-chassis link aggregation (MLAG). A switch apparatus SW (SW1, SW2) illustrated in FIG. 2 includes a control-frame generator CFG, a control-frame monitor CFMONI, and a link relay LKRLY, in addition to typical functions of, for example, a local area network (LAN) switch. The control-frame generator CFG generates a control frame CF2 and periodically sends the control frame CF2 via the port (redundant port) Pr, and the control-frame monitor CFMONI monitors a control frame CF2 received from the port (redundant port) Pr. For instance, in the example of FIG. 1, the control-frame generator CFG in the switch apparatus SW1 sends the control frame CF2, and the control-frame monitor CFMONI in the switch apparatus SW2 monitors the control frame CF2. When the control-frame monitor CFMONI in the switch apparatus SW2 cannot detect, in a predetermined period of time, the control frame CF2 that should be sent from the switch apparatus SW1, the control-frame monitor CFMONI determines that a failure exists in communication going through the port (redundant port) Pr.

The link relay LKRLY has a function for controlling the ports, pre-designated using a setting table or the like, by associating the designated ports with each other. For example, when the control-frame monitor CFMONI detects a failure at the port (the redundant port) Pr, the link relay LKRLY performs control in association with this state to put the ports (user ports) P1 and P2 into the blocking state BK. In the example of FIG. 1, this function of the link relay LKRLY is enabled for only the switch apparatus SW2.

As described above, when the communication system and the processing method therefor according to the first embodiment are used, typically, a low-cost redundant network system that has fewer communication links and so on can be realized with a ring protocol, and when multi-chassis link aggregation (MLAG) is further combined with the communication system, it is possible to achieve a further improvement in failure tolerance, an increase in the communication bandwidth, and so on. Additionally, in such a redundant network system, it is possible to prevent signal loops.

The above description has been given of the redundancy network including the switch apparatuses (the first and second switch apparatuses) SW1 and SW2 to which the multi-chassis link aggregation (MLAG) is applied and the switch apparatus (the fourth switch apparatus, supporting the ring protocol) SWRP connected between the ports (the second ports, uplink port) Pu of the switch apparatuses SW1 and SW2. However, needless to say, the number of switch apparatuses connected between the ports Pu of the switch apparatuses SW1 and SW2 is not limited to one (the switch apparatus SWRP in this case). That is, one or more switch apparatuses can be connected between the ports Pu of the switch apparatuses SW1 and SW2. The redundancy protocol used for the redundancy network is not necessarily limited to a ring protocol, and the Spanning Tree Protocol (STP) or the like may also be used therefor. That is, the redundancy protocol used for the redundancy network may be implemented by a redundancy protocol with which no loop path occurs between the ports (uplink ports) Pu of the switch apparatuses SW1 and SW2 in FIG. 1 when communication is properly performed between the ports (redundant ports) Pr, but a loop path can occur between the ports (uplink ports) Pu when a failure occurs in the communication.

### Second Embodiment

### General Configuration of Communication System

### Application Example

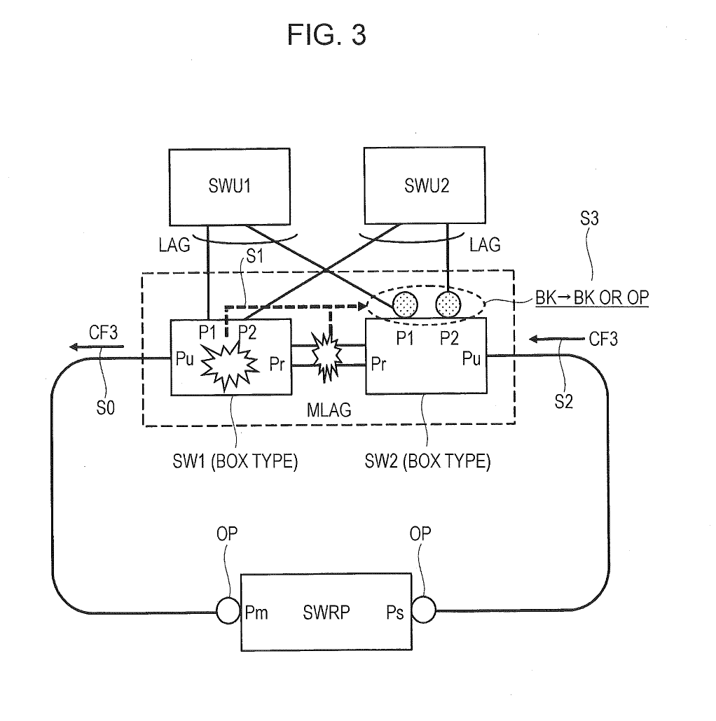

FIG. 3 is a schematic diagram illustrating one example of the configuration of a communication system according to a second embodiment of the present invention. The communication system illustrated in FIG. 3 has a configuration in which box switch apparatuses are used as the switch apparatuses SW1 and SW2 for multi-chassis link aggregation (MLAG) in the communication system described above and illustrated in FIG. 1. Other configurations are substantially the same as those illustrated in FIG. 1. Since the box switch apparatuses are used, the communication system illustrated in FIG. 3 has a main feature in that it has an operation that is an extension of the operation of the communication system described above and illustrated in FIG. 1.

### <Problem Arising in Use of Box Switch Apparatuses>

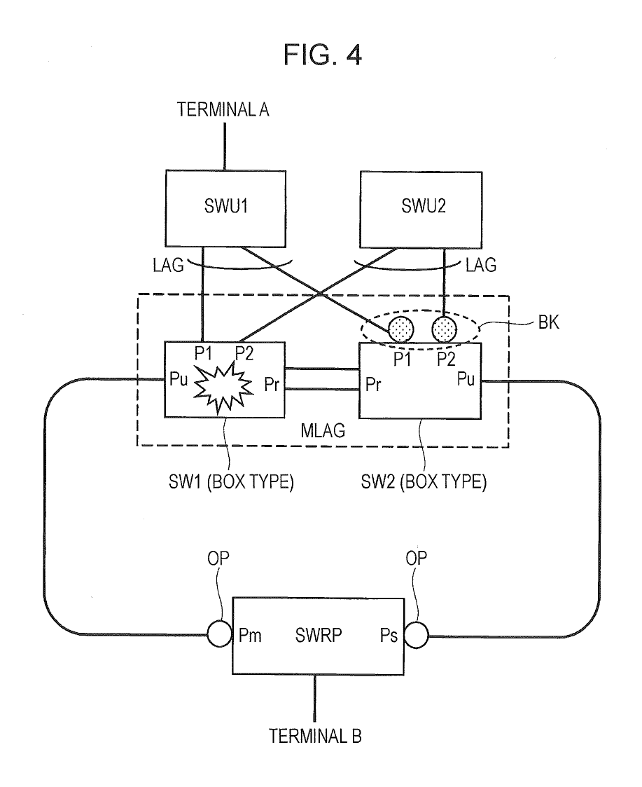

Before the operation of the communication system in FIG. 3 is described, a description will be given of a problem that arises when the switch apparatuses SW1 and SW2 are implemented by box switch apparatuses. FIG. 4 is a block diagram illustrating one example of a problem that is a premise in the communication system illustrated in FIG. 3. FIG. 4 illustrates a communication system including box switch apparatuses SW1 and SW2, as in the case of FIG. 3. In this case, when a failure (e.g., power failure) occurs in the switch apparatus SW1 itself (as in the case illustrated in FIG. 4) during a signal-loop prevention operation as described above in the first embodiment, various communication paths, including, for example, a communication path between a terminal A connected to the switch apparatus SWU1 and a terminal B connected to the switch apparatus SWRP, are disconnected.

As a premise in this case, since the switch apparatus SW2 is a box type, the switch apparatus SW2 cannot distinguish between a case in which a failure has occurred in the switch apparatus SW1 itself or a case in which a failure has occurred in the communication link for bridging (i.e., the shared communication link) between the ports (the redundant ports) Pr of the switch apparatuses SW1 and SW2. Thus, in either of the cases, the switch apparatus SW2 performs control to put the ports (user ports) P1 and P2 into the blocking state BK. Known switch apparatuses are available in a box type and a chassis type. The use of the box type offers advantages in terms of the apparatus cost, the degree of freedom in the installation space, and so on, compared with cases in which the chassis type is used.

In the case of the chassis type, each of the switch apparatuses SW1 and SW2 corresponds to a so-called line card or the like and is managed by, for example, a common processor (a central processing unit (CPU)) or the like included in another card. Thus, the chassis type makes it possible to distinguish between the two cases mentioned above. Accordingly, for example, only when a failure occurs in the communication link for bridging (i.e., the shared communication link) between the ports (redundant ports) Pr, control may be performed to put the ports (user ports) P1 and P2 into the blocking state BK, as described in the first embodiment. On the other hand, in the case of the box type, since each switch apparatus has such a processor (CPU), it is difficult to distinguish between the two cases mentioned above.

### General Operation of Communication System

### Application Example

Accordingly, first, in step S1, the communication system in FIG. 3 detects a communication failure between the ports (redundant ports) Pr and performs control to put the ports (user ports) P1 and P2 of one of the switch apparatuses SW1 and SW2 (the switch apparatus SW2 in this example) into the blocking state BK, as in the case of the first embodiment. Also, in step S0, the other of the switch apparatuses SW1 and SW2 (the switch apparatus SW1 in this example) is pre-set so as to periodically (at predetermined intervals) send a control frame (control signal) CF3 via the port (the second port, uplink port) Pu of the switch apparatus SW1. In step S2, from when the control is performed to put the ports (user ports) P1 and P2 into the blocking state BK in step S1, the aforementioned one of the switch apparatuses SW1 and SW2 (i.e., the switch apparatus SW2) monitors the control frame (control signal) CF3 that should to be sent from the other switch apparatus (SW1) through the communication link between the ports Pu.

In this case, when the aforementioned one of the switch apparatuses SW1 and SW2 (i.e., the switch apparatus SW2) detects the control frame (control signal) CF3 via the port (the second port, uplink port) Pu of that switch apparatus (SW2), it determines that a failure has occurred in the communication link for bridging (i.e., the shared communication link) between the ports (the redundant ports) Pr. In this case, the ports (the third ports, user ports) P1 are P2 are maintained in the blocking state BK. On the other hand, when the aforementioned one of the switch apparatuses SW1 and SW2 (i.e., the switch apparatus SW2) does not detect the control frame (control signal) CF3, the process proceeds to step S3 in which the switch apparatus (SW2) determines that a failure has occurred in the switch apparatus SW1 itself and performs control to cause the ports (user ports) P1 and P2 of the switch apparatus (SW2) to return from the blocking state BK to the open state OP.

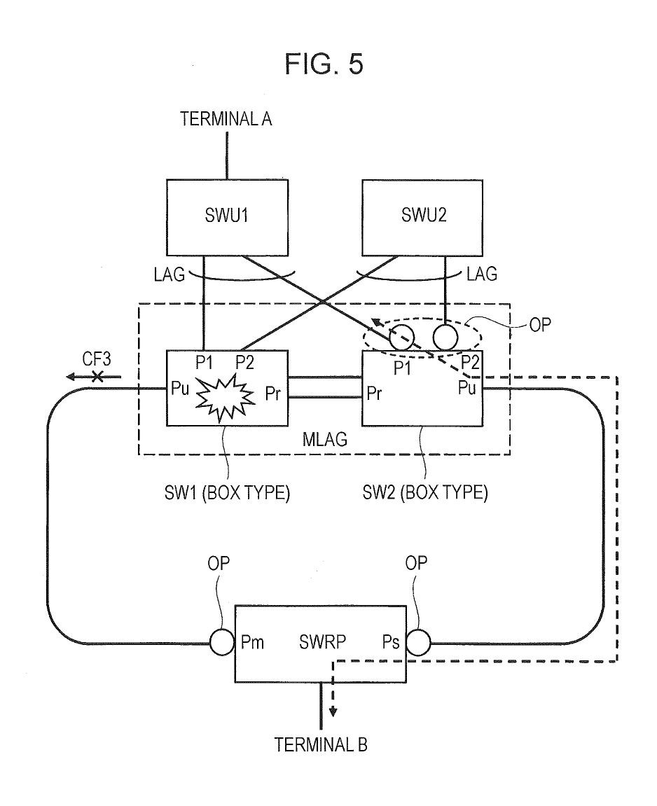

FIG. 5 is a block diagram illustrating one example of an advantage of the communication system illustrated in FIG. 4. FIG. 5 illustrates a state after the ports (user ports) P1 and P2 of the switch apparatus SW2 are changed from the blocking state BK to the open state OP in step S3 described above. As illustrated in FIG. 5, as a result of returning the ports (user ports) P1 and P2 of the switch apparatus SW2 to the open state OP, for example, communication can be performed between the terminal A connected to the switch apparatus SWU1 and the terminal B connected to the switch apparatus SWRP even if a failure occurs in the switch apparatus SW1 itself. In the example of FIG. 5, when a failure occurs in the switch apparatus SW1, a communication path via the switch apparatus SW2 is also ensured automatically by the function of the multi-chassis link aggregation (MLAG). In this case, signal loops RP as illustrated in FIG. 9 are not problematic, since the ports of the switch apparatus SW1 are blocked as a result of the failure.

### Configuration of Major Portion of Switch Apparatus (for MLAG)

### Application Example

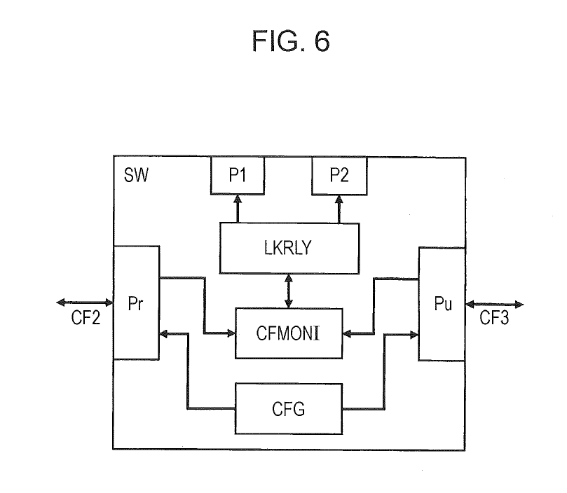

FIG. 6 is a block diagram illustrating an example of the general configuration of a major portion of each of the switch apparatuses SW1 and SW2 (in FIG. 3) constituting the multi-chassis link aggregation (MLAG). A switch apparatus SW (SW1, SW2) illustrated in FIG. 6 is different from the configuration example illustrated in FIG. 2 in that additional operations are added to the control-frame generator CFG, the control-frame monitor CFMONI, and the link relay LKRLY. The control-frame generator CFG generates a control frame CF3 and periodically sends the control frame CF3 via the port (uplink port) Pu, and the control-frame monitor CFMONI monitors a control frame CF3 received from the port (uplink port) Pu. For example, in the case of FIG. 3, the control-frame generator CFG in the switch apparatus SW1 sends the control frame CF3, and the control-frame monitor CFMONI in the switch apparatus SW2 monitors the control frame CF3. When the control-frame monitor CFMONI in the switch apparatus SW2 is not able to detect the control frame CF3 that should to be sent from the switch apparatus SW1, the control-frame monitor CFMONI determines that a failure has occurred in the switch apparatus SW1 itself.

As described above with reference to FIG. 2, for example, when the control-frame monitor CFMONI detects a failure at the port (the redundant port) Pr, the link relay LKRLY performs control in association with this state to temporarily put the ports (the user ports) P1 and P2 into the blocking state BK. However, subsequently, when the control-frame monitor CFMONI does not detect the control frame CF3 from the port (uplink port) Pu, the link relay LKRLY performs control in association with this state to return the ports (user ports) P1 and P2 from the blocking state BK to the open state OP. In the example of FIG. 3, this function of the link relay LKRLY is enabled for only the switch apparatus SW2.

When the communication system and the processing method therefor according to the second embodiment are used, typically, the failure tolerance can be further increased in addition to the advantages described in the first embodiment.

### Third Embodiment

### General Configuration of Communication System (Modification)

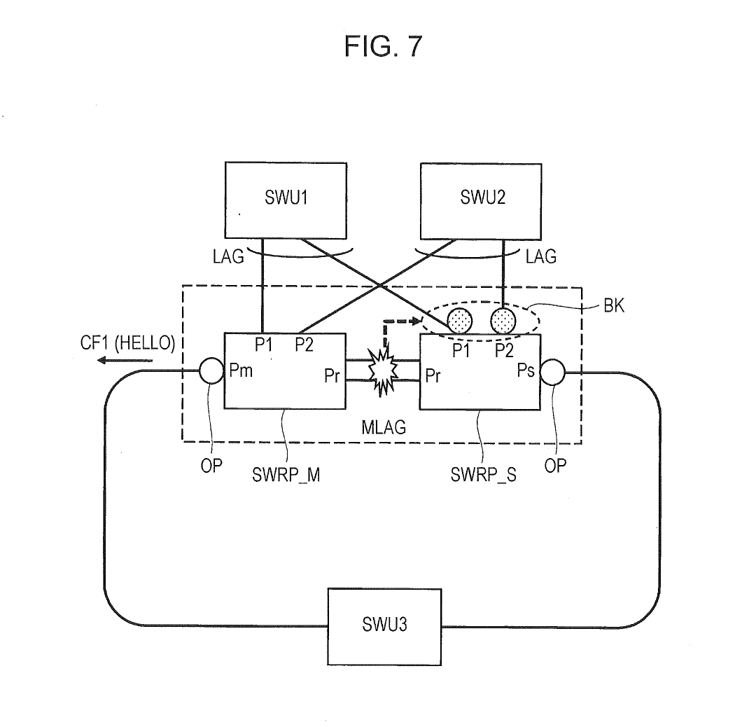

FIG. 7 is a schematic diagram illustrating one example of the configuration of a communication system according to a third embodiment of the present invention. The communication system illustrated in FIG. 7 includes two switch apparatuses (first and second switch apparatuses) SWRP_M and SWRP_S supporting a ring protocol, a switch apparatus SWU3, and switch apparatuses SWU1 and SWU2, which are connected to the switch apparatuses SWRP_M and SWRP_S. The switch apparatuses SWRP_M and SWRP_S and the switch apparatus SWU3 are included in a ring network. In this example, a port (a master port) Pm of the switch apparatus SWRP_M is connected to a port (a slave port) Ps of the switch apparatus SWRP_S through a communication link on which the switch apparatus SWU3 is provided.

Similarly to the switch apparatuses SW1 and SW2 illustrated in FIG. 1, the switch apparatuses SWRP_M and SWRP_S have ports (redundant ports) Pr that are connected to each other through a communication link for bridging (i.e., a shared communication link), thereby realizing multi-chassis link aggregation (MLAG). The relationship of connections between the switch apparatuses SWRP_M and SWRP_S and the switch apparatuses SWU1 and SWU2 is substantially the same as the relationship of connections between the switch apparatuses SW1 and SW2 and the switch apparatuses SWU1 and SWU2 illustrated in FIG. 1, and a function of multi-chassis link aggregation (MLAG) therefor is also the same as or similar to the function in the case of FIG. 1. In the communication system illustrated in FIG. 7, a redundancy protocol with which multiple switch apparatuses supporting a ring protocol can be provided in a ring network is utilized to arrange two switch apparatuses (i.e., the switch apparatuses SWRP_M and SWRP_S) and the multi-chassis link aggregation (MLAG) is applied thereto.

### <Overview of Ring Protocol (Modification)>

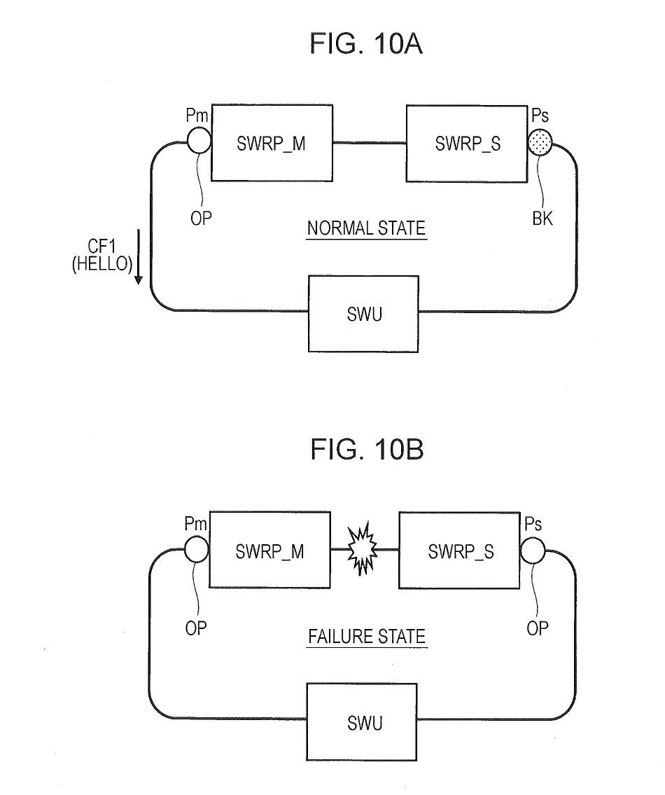

FIGS. 10A and 10B are block diagrams illustrating an example of the general operation for a ring protocol, the operation being different from that in FIGS. 8A and 8B. In the ring protocol illustrated in FIG. 10A and FIG. 10B, for example, two switch apparatuses SWRP_M and SWRP_S supporting the ring protocol are provided. A port (master port) Pm of the switch apparatus SWRP_M is connected to a port (slave port) Ps of the switch apparatus SWRP_S through a communication link and one or more switch apparatuses (SWU) provided on the communication link. In addition, another port of the switch apparatus SWRP_M and another port of the switch apparatus SWRP_S are directly connected to each other through a shared link. This topology implements a ring network.

In a normal state in which no failure exists in the ring network, for example, the switch apparatus SWRP_M puts the port (the master port) Pm into the open state OP and the switch apparatus SWRP_S puts the port (the slave port) Ps into the blocking state BK, as illustrated in FIG. 10A. This prevents signal loops in the ring network. On the other hand, when a failure occurs in the ring network (e.g., when a failure occurs in the communication link for bridging between the switch apparatuses SWRP_M and SWRP_S), the switch apparatus SWRP_S changes the port Ps thereof from the blocking state BK to the open state OP, as illustrated in FIG. 10B. This ensures a communication path in the ring network without occurrence of signal loops. The presence/absence of a failure in the ring network can be determined by sending/receiving a control frame CF1 (e.g., a frame including information called “hello”) between the port Pm of the switch apparatus SWRP_M and the port Ps of the switch apparatus SWRP_S or sending/receiving a control frame using a shared link.

### <General Operation of Communication System (Modifications)>

When the communication system illustrated in FIG. 7 is put into a failure state as illustrated in FIG. 10B, the problem of signal loops RP can occur as in the case of FIG. 9. Accordingly, the communication system in FIG. 7 performs an operation that is similar to that in the communication system described and illustrated in FIG. 1, to thereby prevent the signal loops RP. In addition, the communication system in FIG. 7 avoids the problem of communication disconnection that may occur in this case, by performing an operation that is similar to the operation of the communication system illustrated in FIG. 3. In this case, the switch apparatuses SWRP_M and SWRP_S essentially have the function for monitoring the state of the ring network by sending/receiving the control frame CF1 or the like. Thus, for example, compared with the communication system illustrated in FIG. 3, the scheme of the present embodiment can easily be applied.

Although the present invention made by the present inventor has been specifically described above in conjunction with the embodiments, the present invention is not limited to the above-described embodiments and various changes and modifications can be made thereto without departing from the spirit and scope of the present invention. For example, it is to be noted that the above embodiments have been described in detail in order to facilitate understanding of the present invention and are not necessarily limited to those having the entire configuration described above. A portion of a configuration in one embodiment can be replaced with a configuration in another embodiment and a configuration in one embodiment can also be added to a configuration in another embodiment. A configuration in one embodiment can also be added to, deleted from, or replaced with a portion of a configuration in another embodiment.

For example, although a communication system using LAN switches (layer 2 switches) has been manly described above by way of example, the present invention is similarly applicable to a communication system using layer 3 switches.

What is claimed is:

1. A communication system comprising:
a redundancy network including first and second switch apparatuses each having a first port, a second port, and a third port, the first ports of the first and second switch apparatuses being connected to each other through a shared communication link and the second ports of the first and second switch apparatuses being connected to each other via at least one switch apparatus; and
a third switch apparatus connected with the third ports of the first and second switch apparatuses through corresponding communication links to operate with link aggregation being set for the communication links,
wherein, when a failure occurs in communication between the first ports of the first and second switch apparatuses, the redundancy network causes an actual data signal to be transmitted between the second ports of the first and second switch apparatuses in accordance with an arbitrary redundancy protocol, and
when a failure occurs in communication between the first ports of the first and second switch apparatuses, the first switch apparatus performs control to put the third port of the first switch apparatus into a blocking state in which the actual data signal is blocked.

2. The communication system according to claim 1, wherein the redundancy protocol comprises a ring protocol.

3. The communication system according to claim 2, wherein
the at least one switch apparatus comprises a fourth switch apparatus supporting the ring protocol, the fourth switch apparatus having two ports connected to the ring network; and
the fourth switch apparatus performs control to put one of the two ports into the blocking state and performs control to put the other of the two ports into an open state in which the actual data signal is transmitted, when no failure exists in the ring network, and performs control to put both of the two ports into the open state, when a failure exists in the ring network.

4. The communication system according to claim 3, wherein
the second switch apparatus sends a control signal via the second port thereof at predetermined intervals, and
the first switch apparatus performs control to put the third port thereof into the blocking state in response to a communication failure between the first ports of the first and second switch apparatuses, and, when the first switch apparatus does not detect the control signal from the second switch apparatus via the second port of the first switch apparatus, the first switch apparatus performs control to put the third port thereof into the open state.

5. The communication system according to claim 2, wherein both of the first and second switch apparatuses support the ring protocol.

6. The communication system according to claim 5, wherein
one of the first and second switch apparatuses performs control to put the second port of the one switch apparatus into an open state in which the actual data signal is transmitted, and
the other of the first and second switch apparatuses performs control to put the second port of the other switch apparatus into the blocking state, when no failure exists in the ring network, and performs control to put the second port of the other switch apparatus into the open state, when a failure exists in the ring network.

7. A processing method for a communication system having
a redundancy network including first and second switch apparatuses each having a first port, a second port, and a third port, the first ports of the first and second switch apparatuses being connected to each other through a shared communication link and the second ports of the first and second switch apparatuses being connected to each other via at least one switch apparatus, and
a third switch apparatus connected with the third ports of the first and second switch apparatuses through corresponding communication links to operate with link aggregation being set for the communication links, the processing method comprising:
causing, when a failure occurs in communication between the first ports of the first and second switch apparatuses, the communication system to transmit an actual data signal between the second ports of the first and second switch apparatuses in accordance with an arbitrary redundancy protocol and to perform control to put the third port of the first switch apparatus into a blocking state in which the actual data signal is blocked.

8. The processing method according to claim 7, further comprising:
causing the communication system to monitor, at the second port of the first switch apparatus, a control signal sent from the second port of the second switch apparatus, after performing the control to put the third port of the first switch apparatus into the blocking state, and to perform control to put the third port of the first switch apparatus into an open state in which the actual data signal is transmitted, when the control signal is not detected.
